(19) United States
(12) Patent Application Publication
(10) Pub. No.: US 2016/0332079 A1
(43) Pub. Date: Nov. 17, 2016

(54) Electronic Environment Interaction Cyborg

(71) Applicant: Jonathan Mugan, Buda, TX (US)

(72) Inventor: Jonathan Mugan, Buda, TX (US)

(21) Appl. No.: 14/710,760

(22) Filed: May 13, 2015

(51) Int. Cl. A63F 13/57; G06N 7/00; G06N 5/02

(52) U.S. Cl. CPC A63F 13/57; G06N 5/02; G06N 7/005

(57) ABSTRACT

The present invention is a system and method for uploading an owner's personality to a digital environment and enabling a cyborg to work on the owner's behalf in that environment. The cyborg may take the actions that the owner would take in that digital environment. The cyborg may also act as a filter and use the personality of the owner to determine which events in the digital environment the owner would like to see. This invention allows an owner to increase his or her reach in the digital environment by automating tasks.

### CROSS-REFERENCE TO RELATED APPLICATIONS

This application claims the benefit of PPA Ser. No. 61/992,886, filed 2014 May 14 by the present inventors, which is incorporated by reference.

### TECHNICAL FIELD

The present invention relates to automated interaction in digital environments.

### BACKGROUND ART

We now live much of our lives in digital environments where our behavior can be recorded. Many of our conversations occur on social media, and many of our actions take place in the virtual worlds, such as those of massively multiplayer online games (MMOGs). Since our behavior can be recorded in these domains, an essence of ourselves can be captured and played back. We would like this essence to be combined with automation to form an agent that can be used to help achieve our goals.

We would like to use an agent to automate many of the tedious tasks in digital environments. In MMOGs, these tasks may be such things as mining ore or killing low-level adversaries to gain experience points. One can use pre-programmed bots, but bots are often brittle and limited in abilities. One can also hire someone else to do the tedious work, but this person may not perform to our wishes.

In the social media domain, having an agent perform actions on our behalf can extend our reach. There exist methods such as CrowdFire for Twitter, which can automatically follow the followers of other people, alert you when someone unfollows you, or send automated direct messages. But these methods are often insufficiently targeted and can be annoying to other social media users. There are also “bots” that automatically respond to people who use certain keywords, but these responses are often non sequiturs that are not welcomed by the recipient.

### SUMMARY OF THE EMBODIMENTS

A system for transporting part of one's personality to a digital environment so that an agent in that environment can act autonomously as you would in that environment. You feed a representation of your desires or previous actions to the agent. The agent then interacts with the environment and searches for situations where it believes it knows what you would likely do, and it performs the actions that it believes you would perform in those situations. The present invention also performs a filtering service by using the representation of your actions to determine which events in that environment would be of interest to you.

### ADVANTAGES

The present invention allows one to extend the reach of oneself and one's personality by empowering an agent to act on one's behalf in a digital domain. We call such an agent, infused with the personality or desires of an owner, a cyborg.

Consider the example of social media. One of my favorite aspects of social media is knowing that my personality is going out there in the world—that my thoughts are getting into someone else's head. The present invention allows one to extend the reach of one's personality through automatic interaction and relationship building. When interacting on Twitter, I found that I often responded in the same way to the same statements. For example, whenever someone would mention Cormac McCarthy, I would reply that The Road was one of my favorite books. The present invention allows me to only have to type in this response once. Not only does this save time, but when you only have to enter in a response once, you can take the time to craft a high-quality response, and you can make sure that everything is spelled correctly and worded well. This benefit also extends to other domains, such as telemedicine. Using the present invention, a medical doctor, for example, would only have to explain the consequences of a test result once, and it could be played back whenever the appropriate context arose. Since it would only have to be performed once, she could make sure that her explanation was complete and high quality.

The cyborg acts in a digital environment without being annoying to other users. It uses the owner's personality and can optionally only interact with other users when it can approximate how the owner would behave. Below we list some of the advantages of this invention in terms of the behaviors that can be performed by the cyborg. We provide examples in MMOGs and social media to give the reader a sense of the meaning and benefits of these behaviors, but the invention is not limited to those types of digital environments.
a. Response behavior is taking actions triggered by the environment similarly to how the owner would. In an MMOG environment, response behavior may be attacking when encountering a particular kind of entity. In a social media environment, response behavior may be posting a communication in response to a communication from another user.
b. Baseline behavior is behaving similarly to how the owner would in the environment. Baseline behavior is distinguished from response behavior because it is the default behavior when the cyborg is not engaged in response behavior. In an MMOG environment, baseline behavior may be mining for ore. In a social media environment, baseline behavior may include broadcasting communications, such as tweets.
c. Connecting behavior is subscribing to information resources that may be of interest to the owner. These information sources include news feeds or other users in the digital environment. It is often beneficial to build a community around an idea, brand, or set of shared interests. In an MMOG, connecting behavior may include building a coalition. In social media environments, one can often choose whom to reach out to. For example, on Twitter, one can decide whom to follow.
d. Filtering behavior is identifying aspects of the environment that would be of interest to the owner and showing them to the owner, and possibly rebroadcasting them to other users. In an MMOG environment, an owner might want to be notified when certain events occur, such as when a character comes near to a dwelling. In social media environments, there can often be so many communications that it can be hard to find the content that one really wants to see. A filter can allow one to only see communications, such as tweets, of interest. One may also want to serve as a filter for one's community, so you can rebroadcast some events that you consider to be important.
e. Ad hoc behavior is other behaviors that are only done once or periodically.

The present invention also allows one's actions to become a product of value because those actions could be used by someone else to perform useful work. Through this process, the present invention allows one to create a new kind of property: one's action patterns. This property could be valuable because the pattern of actions that one would take in any situation could be useful to someone else, for example in situations where one's pattern of actions was representative of expertise in a domain.

### BRIEF DESCRIPTION OF THE DRAWINGS

FIG. 1 depicts the invention at a high level.

FIG. 1A depicts how the cyborg interacts with the digital environment.

FIG. 1B depicts how the environment state is tokenized.

FIG. 2 depicts a tokenized embodiment.

FIG. 3 depicts an example context-sensitive action mapping.

FIG. 4 depicts a screenshot of the cyborg responding to a tweet using the context-sensitive action mapping.

FIG. 5 depicts a second screenshot of the cyborg responding to a tweet using the context-sensitive action mapping.

FIG. 6 depicts how the tokenized embodiment performs response behavior.

FIG. 7 depicts how the tokenized embodiment performs connecting behavior.

FIG. 8 depicts how the tokenized embodiment performs filtering behavior.

FIG. 9 depicts a vectorized embodiment.

FIG. 9A depicts how the vectorized embodiment performs response behavior.

FIG. 10 depicts an alternative vectorized embodiment with a vector embedding engine.

FIG. 10A depicts how the alternative vectorized embodiment with a vector embedding engine performs multiple behaviors

FIG. 11 depicts a context-free decoder model.

FIG. 11A depicts using the context-free decoder model to perform baseline behavior.

FIG. 11B depicts using the context-free decoder model to perform filtering behavior.

### DETAILED DESCRIPTION OF SPECIFIC EMBODIMENTS

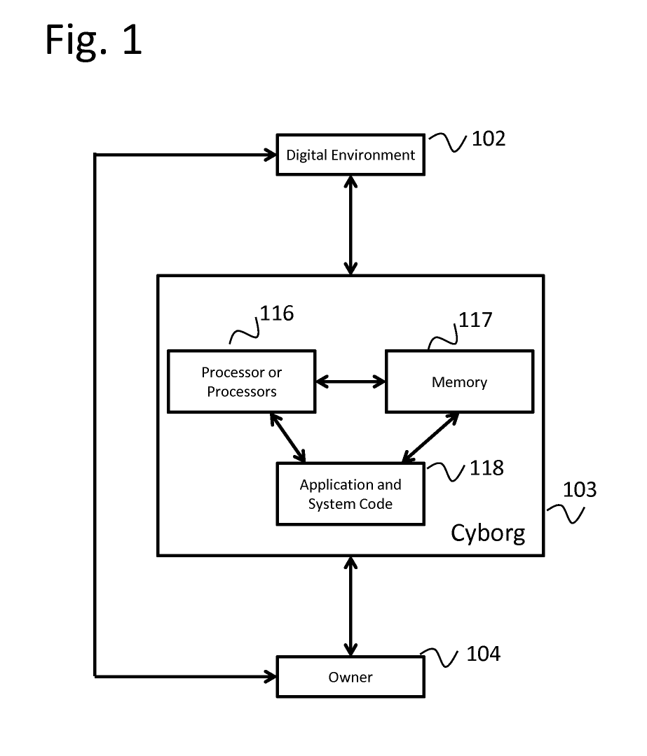

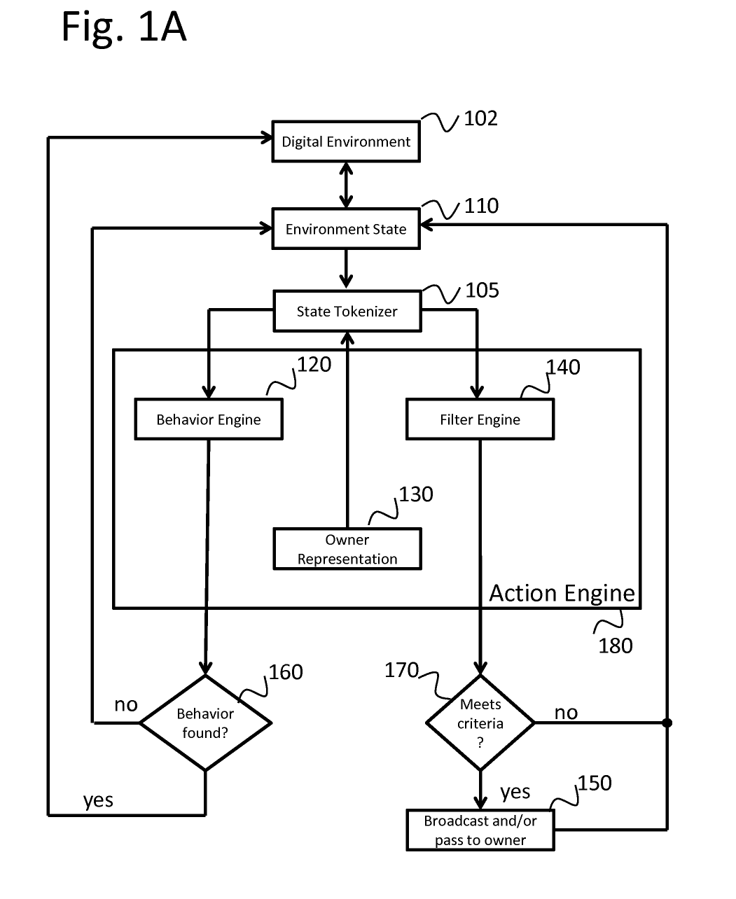

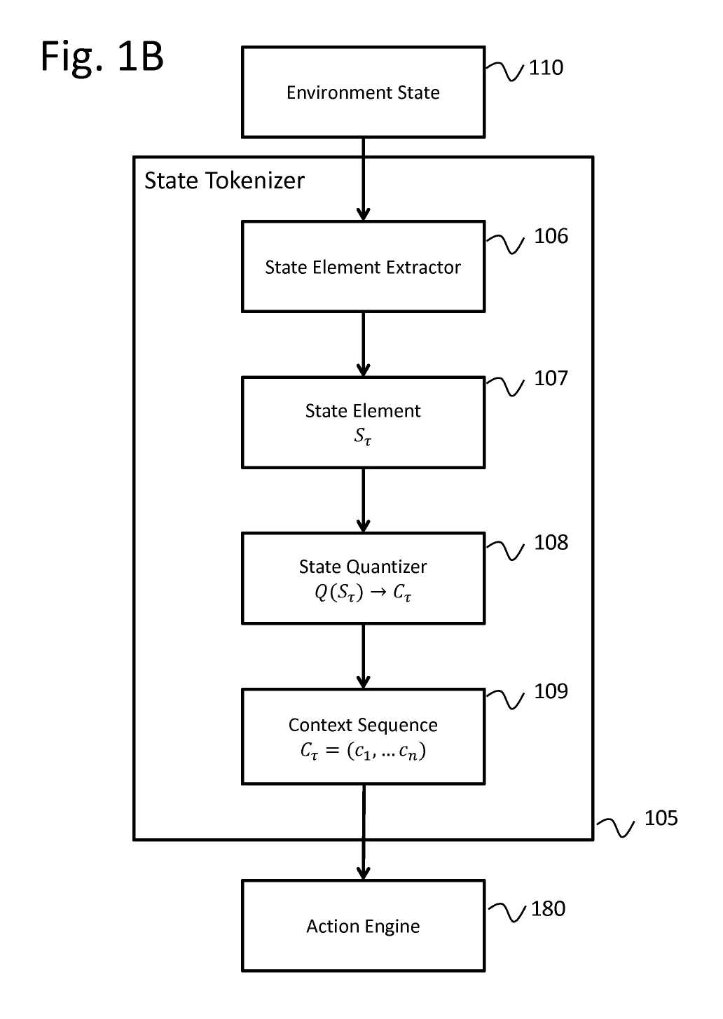

### FIG. 1, Cyborg Overview

FIG. 1 shows an overview of the invention. The owner 104 is the person whose personality or desires are transferred to the digital environment 102. The personality of the owner 104 is the actions that the owner 104 would take in different situations in the digital environment 102. The owner 104 can interact with the cyborg 103 to upload behavior history or to specify his or her preferences, or the owner 104 can interact directly with the digital environment 102 so that some actions on the owner's 104 behalf may be taken by the cyborg 103 and some may be taken directly by the owner 104.

The digital environment 102 is an environment that is generated by a computer or a network of computers in which entities can interact. Examples of digital environments 102 include social media sites such as Twitter or Facebook and Massive Online Multiplayer Games (MMOGs) such as Eve Online, Minecraft, and World of Warcraft. Humans and agents for humans can interact with a digital environment 102 by communicating with the environment interface using inputs such as a keyboard or mouse. Environment interfaces can also take the form of an Application Programming Interface (API).

When an entity in a digital environment 102 represents the interests of a human, we call it a user. Entities may generate actions in the environment, such as a user posting message to social media, and entities may have metadata associated with them, such as a user description on social media.

The cyborg 103 interacts with the owner 104 to receive preferences and to show filtered events, and the cyborg 103 also interacts with the environment. The cyborg 103 is a computer system that comprises a processor or processors 116 (such a one or more CPUs), a memory 117, and application and system code 118 that performs the necessary administrative processes of the computer system and the application code. The computer system can run either on a personal computer or in a cloud environment. The cyborg 103 may interact with the human using a user interface where the human uses a keyboard or mouse. The cyborg 103 may interact with the digital environment 102 using an API or other means.

FIG. 1A, Cyborg Interaction with the Digital Environment

The cyborg 103 retrieves what is going on in the digital environment 102 using the environment state 110. The environment state 110 extracts a representation of what is currently going on in the digital environment 102 by querying information feeds in the digital environment 102. Digital environments 102 are often huge and create too much information to be consumed in their entirety. Therefore, digital environments 102 can produce multiple information feeds. For example, in a social media environment, one would see the communications of the people one follows as well as notifications from the service, such as a notification that another user has enjoyed one of your posts. In an MMOG, the environment state 110 may consist of the local surroundings of the agent in the virtual world, and there additionally can be feeds for events not happening in the immediate vicinity, such as through an online map or chat window.

The environment state 110 contains the functionality to access feeds from the digital environment 102, such as through an API. The feeds accessed by the environment state 110 are passed to the state tokenizer 105. The state tokenizer plugs into information feeds from the environment state 110 and converts them into a tokenized state consisting of sequences of discrete tokens.

The tokenized state is passed to the action engine 180, which includes the behavior engine 120, the owner representation 130, and the filter engine 140. The behavior engine 140 considers the owner representation 130 and the environment state 110 and determines 160 if there is a behavior that the owner 104 would take in any situation entailed by the environment state 110. These behaviors can include such actions a making communications (such as Tweets) in social media environments, requests to follow certain users in social media, or actions such as attacking a character in an MMOG. The filter engine 140 considers the owner representation 130 and the environment state 110 and determines whether the state should be shown to the owner 104 or possibly broadcast to other users.

### FIG. 1B, the State Tokenizer

The state tokenizer 105 converts feeds from the environment state 110 into sequences of discrete tokens. As depicted in FIG. 1B, the state element extractor 106 plugs into an information feed in the environment state 110 and produces a series of state elements 107, each denoted by S_{τ}. For natural language environments such as social media, a state element 107 S_{τ} could be a communication τ, such as a tweet. For visual environments, such as video games, a state element 107 S_{τ} could be the current state of the game, such as the current frame τ shown to the user.

The state quantizer 108 E(S_{τ})→C_{τ} converts each state element 107 S_{τ} into a sequence of tokens called a context sequence 109 C_{τ}. The context sequence 109 C_{τ}=(c₁, . . . cₙ) is a k-dimensional ordering over n context tokens. Each context token can be mapped to an integer identifier. For a communication in a natural language environment, the context sequence 109 C_{τ} could be a sequence of context tokens where each context token is a word, where each word can be given an integer identifier as a member of the set of all of the possible words. For example, the word “taco” could always be represented by the integer value 415. For visual environments, such as video games, C_{τ} could consist of the objects in the character's environment ordered in k=2 dimensions or k=3 dimensions by their relationship to the character. Here again, each object in a visual environment can be mapped to an integer identifier as a member of the set of all possible objects. In digital environments 102, such as natural language environments and visual environments, the conversion of information feeds into context sequences 109 can be done by anyone of ordinary skill in the art.

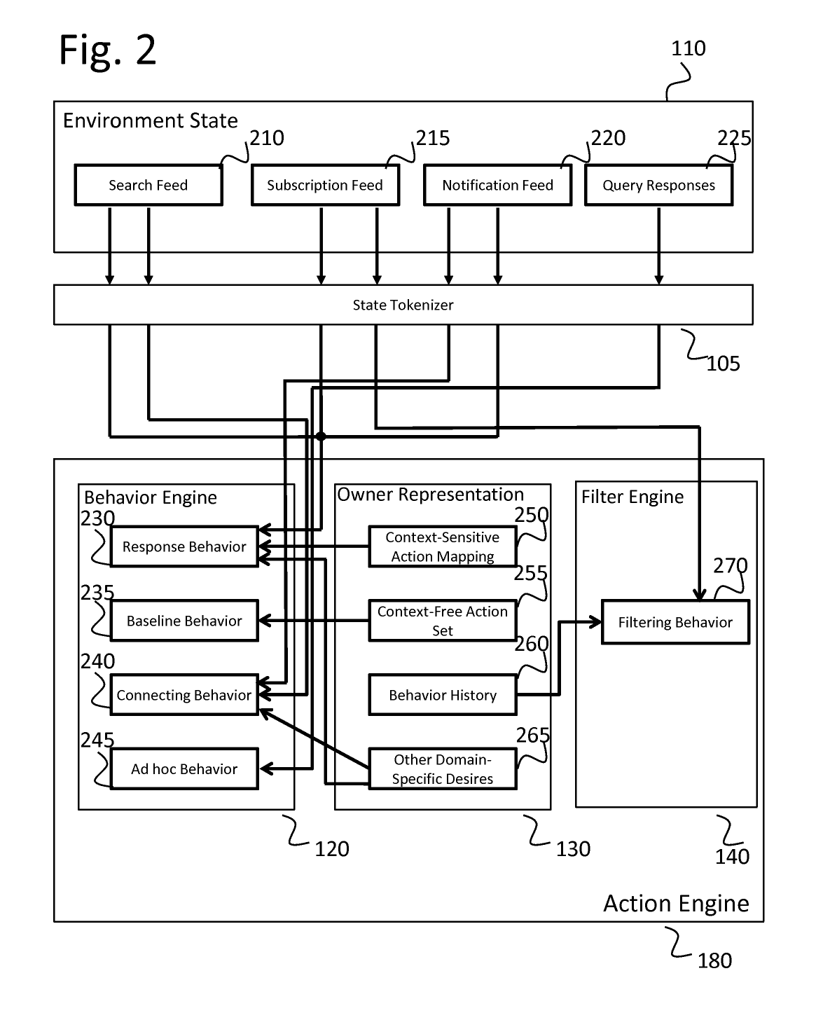

### FIGS. 2, 3, 4, and 5, Tokenized Embodiment

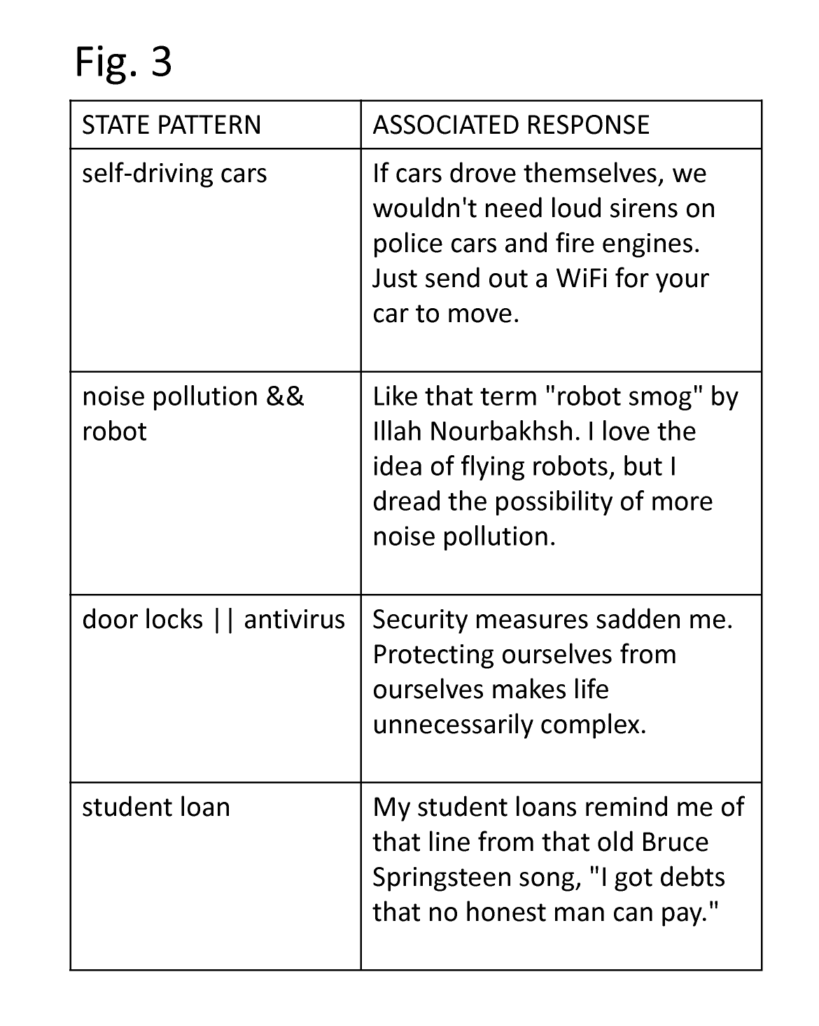

FIG. 2 depicts the environment state 110, state tokenizer 105, and the action engine 180 of the tokenized embodiment. We refer to it as a tokenized embodiment because this embodiment makes direct use of the context tokens generated by the state tokenizer 105. FIGS. 3, 4, and 5 provide additional details.

The environment state 110 may provide a plurality of feeds, including
1. Search Feed 210 provides state elements 107 that match search criteria as described by the search pattern set (described under other domain-specific desires 265). An example from social media would be tweets containing a key word or tweets from a particular location. Alternatively, the search feed could be the main feed. An example would be the environment of a character as it travels through a virtual world.
2. Subscription Feed 215 provides state elements 107 from a particular set of connections, possibly set up through connecting behavior. For example, the subscription feed could consist of tweets from the Twitter users the cyborg 103 is following on behalf of the owner 104. In other digital environments 102, it could be any source of information that the cyborg 103 connected to.
3. Notification Feed 220 provides state elements 107 that mention the owner 104, for example, tweets where the owner 104 was mentioned or retweeted.
4. Query Responses 225 provides results to specific queries asked of the digital environment 102. For example, in Twitter, one can find out if he or she is followed by another user.

The action engine 180 includes the behavior engine 120, the owner representation 130, and the filter engine 180.

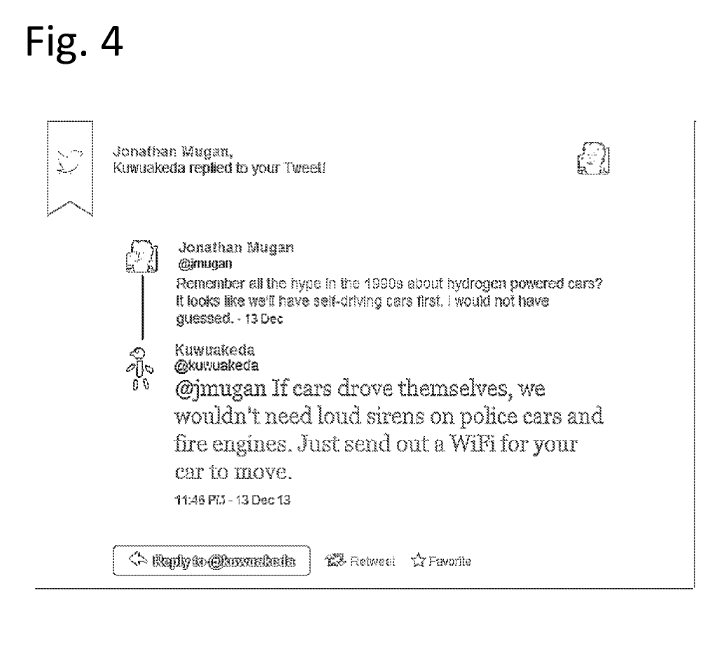

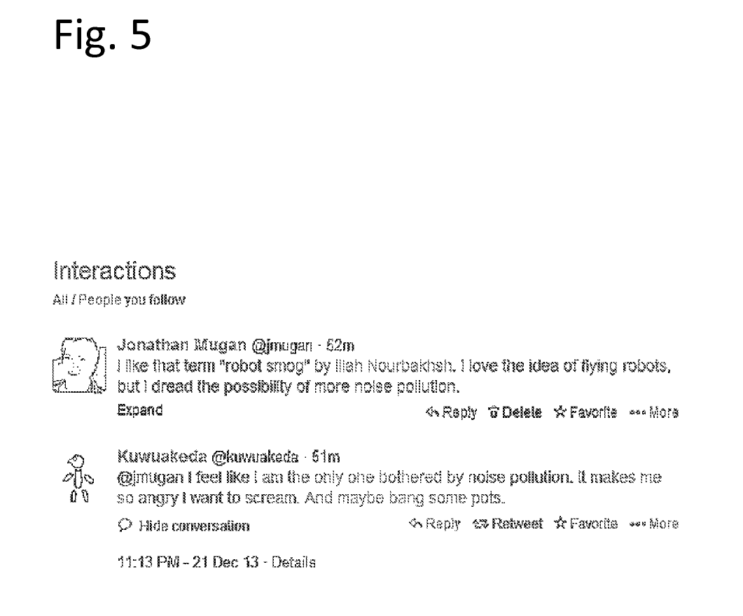

The owner representation 130 may include the following sources of information:
1. Context-Sensitive Action Mapping 250—a mapping of state patterns to associated responses. State patterns are regular expressions over sequences of context tokens. As an example in a natural language environment, state patterns could be parts of phrases, as depicted in FIG. 3. State patterns can just be sequences of tokens, as in the first line. If the phrase “self-driving cars” appears in a context sequence 109, such as a tweet separated into words, then the agent can respond with the associated response, as we see in FIG. 4. State patterns can also require multiple parts (such as a logical “and” denoted by “&&”). In the second line of FIG. 3, we see that if the phrase “noise pollution” and the phrase “robot” both appear in a context sequence 109, such as the words of tweet, the cyborg 103 can respond with the associated response, as is shown in FIG. 5. Similarly, state patterns can consist of multiple parts, where each can trigger the associated response (a logical “or” denoted by “∥”). We see in the third line that that response can be triggered by the context tokens “door locks” or by the context token “antivirus” appearing in a context sequence 109.
2. Context-Free Action Set 255—These are the previous actions of the owner 104 in this digital environment 102, such as the previous tweets of the owner 104.
3. Behavior History 260—This can be a corpus of previous actions of the owner 104 in the current digital environment 102 or any other digital environment 102. In a natural language environment, examples include the owner's 104 tweets, blog posts, journal entries, or anything written by the owner 104.
4. Other Domain-Specific Desires 265
   a. Token-value dictionary—A mapping of context tokens to values that represents the desires of the owner 104. Positive tokens have a positive value, and negative tokens have a negative value. For example, if the owner 104 is interested in computers but not restaurants, a context token that corresponds to the natural language term “computer” could have a score of 5, but the context token “appetizer” could have a score of −5.
   b. Offensive-token set—A set of offensive tokens. The owner 104 may choose for the cyborg 103 to avoid interacting with any state element 107 that contains any such token.
   c. Search-pattern set—A list of context tokens (or regular expressions over context tokens) that are used to create a search feed. The search pattern set represents the interests of the owner 104.

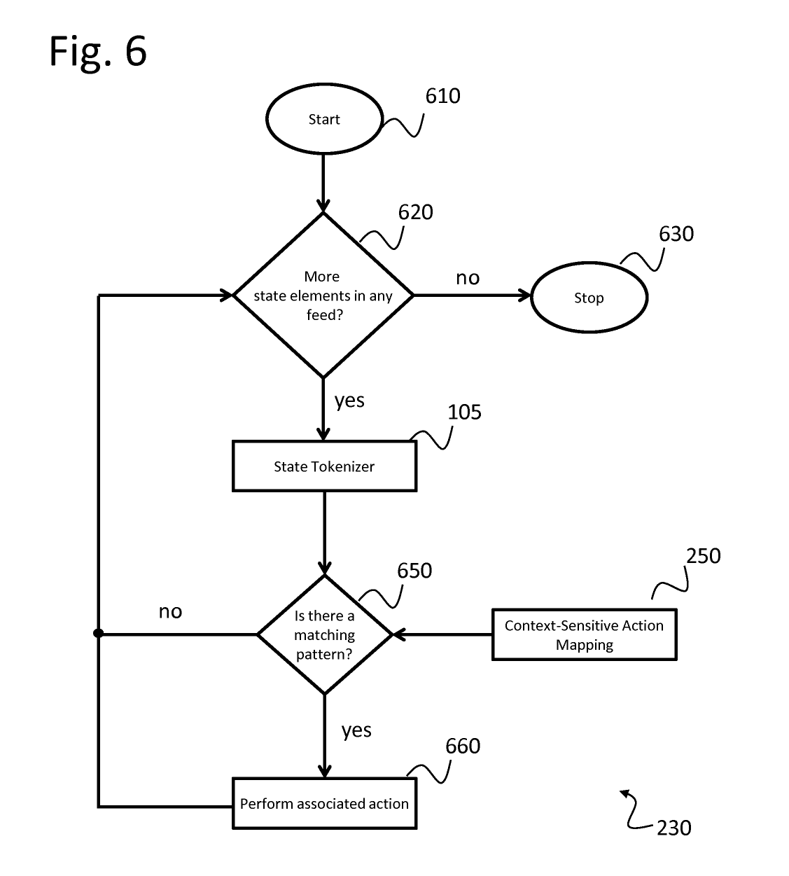

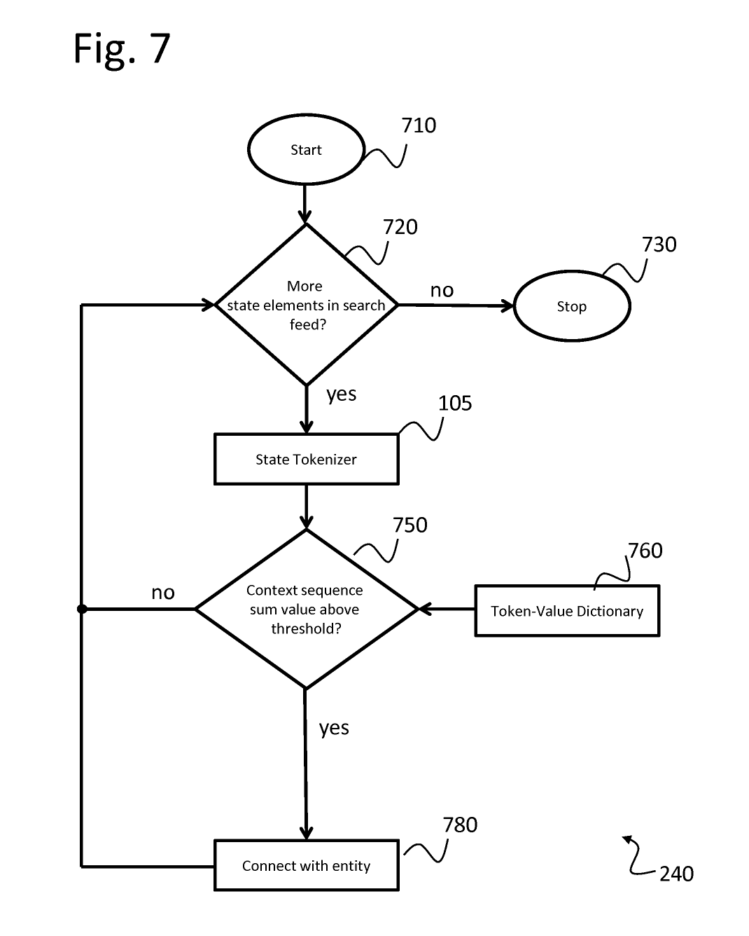

Details for response behavior and connecting behavior for the behavior engine 120 are provided in subsequent sections on FIGS. 6 and 7. The cyborg 103 can perform baseline behavior 235 as part of the behavior engine 120. For example, in a social media environment such as Twitter, the cyborg 103 can select communications (such as tweets) from the context-free action set 255 and broadcast them (such as by tweeting) periodically.

The behavior engine 120 can also perform ad hoc behavior 245. One ad hoc behavior is adding users to public lists. When a user interacts with the cyborg 103, the cyborg 103 makes the assumption that the user is interested in the personality of the owner 104 and adds that person to a public list. The user added to the list knows that the interaction has been appreciated, and this helps to build the relationship.

Another ad hoc behavior 245 is disconnecting from users. Disconnecting (for example, “unfollowing” on Twitter) is sometimes necessary because a digital environment 102 may limit the number of users that one may connect with based on how many users connect with one. If one wants to build up a large body of connections, it becomes required to disconnect from those that do not reciprocate the connection. If the connected user does not reciprocate within a specified number days of when the connection was made, the cyborg 103 may disconnect from that user.

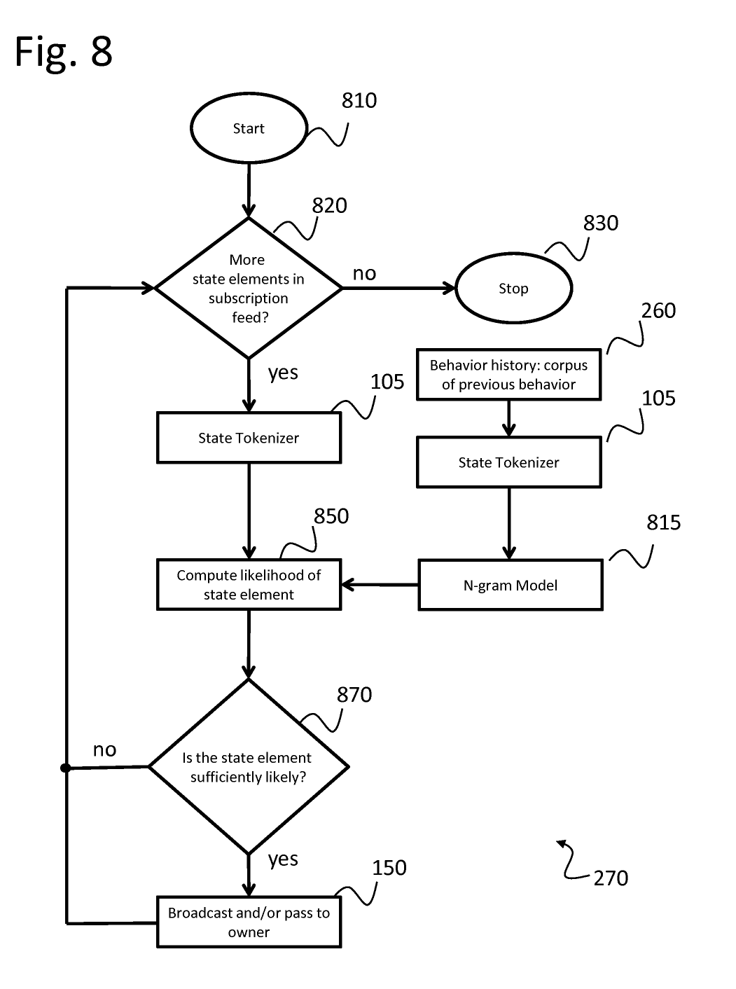

The filter engine 140 considers all state elements 107 occurring in the digital environment 102 and filters those down to a small set of state elements 107 that might be of interest to the owner 104 and shows them to the owner 104, and possibly broadcasts them to other users 150. It does this using the owner representation 130 by looking for state elements 107 that are similar to those generated by the previous actions of the owner 104. The filter engine can optionally take an action that lets the user who generated the state element 107 know that the cyborg 103 (and, by extension, the owner 104) found the state element interesting. For example, the cyborg 103 may “like” or “favorite” a social media communication of another person. Additional details of filtering behavior are given in FIG. 8.

### FIG. 6, Response Behavior Using the Tokenized Embodiment

FIG. 6 depicts response behavior using the tokenized embodiment. The cyborg 103 monitors the environment, and, when possible, the cyborg 103 responds to the environment in a similar way that the owner 104 would. One benefit of this embodiment is that it doesn't always respond, both because the owner 104 wouldn't always respond and because the cyborg 103 isn't smart enough to always respond without annoying other users. The cyborg 103 only responds when one of the context sequences 109 matches the context-sensitive action mapping. Consider the example of the social media environment, Twitter. Each context sequence 109 could be the words of a tweet, and the cyborg 103 would respond to the tweet with a tweet.

In FIG. 6, the state tokenizer continually extracts a state element 107 whose associated context sequence 109 is passed to block 650 (which is an embodiment of block 160). Block 650 loops over the state patterns in the context sensitive action mapping 250, and if a match is found (the regular expression of the state pattern matches the context sequence 109) the associated action is performed 660.

FIGS. 3 and 4 depict examples of this process in the social media environment Twitter. The cyborg 103 in these examples is the user @kuwuakeda. Looking at FIG. 4, if, in an embodiment of the state tokenizer, tokens were created by dividing on spaces between words and the tokens were lowercased and only words were included, the context sequence 109 could be computed by the state tokenizer 105 to be (‘remember’, ‘all’, ‘the’, ‘hype’, ‘in’, ‘the’, ‘1990s’, ‘about’, ‘hydrogen’, ‘powered’, ‘cars’, ‘it’, ‘looks’, ‘like’, ‘we'll’, ‘have’, ‘self-driving’, ‘cars’, ‘first’, ‘i’, ‘would’, ‘not’, ‘have’, ‘guessed’). The first state pattern in FIG. 3, ‘self-driving cars’ would match, and the cyborg 103 would take the responses shown in FIG. 4. We see another example of a response in FIG. 5.

The cyborg 103 can optionally take the following additional precautions to avoid annoying other users in the digital environment 102:
1. The cyborg 103 may optionally only respond to state elements 107 from users that have agreed to interact with the cyborg 103, for example by being connected with the cyborg 103. This is to prevent the cyborg 103 from annoying people who are not interested in interacting with it. For example, on Twitter, the cyborg 103 could only respond to users who follow it.
2. The cyborg 103 may optionally not repeat responses until reset by the owner 104. This is to prevent the cyborg 103 from making the same action repeatedly and annoying other users.
3. The cyborg 103 may optionally never repeat the same response directed at the same user twice.

The cyborg 103 can also optionally not respond to any context sequence 109 with an offensive token in it using the offensive-token set 265.

### FIG. 7, Connecting Behavior Using the Tokenized Embodiment

FIG. 7 depicts connecting behavior using the tokenized embodiment. Connections can be established with entities to see information or to build a relationship when that entity is a user. In a social media environment, such as Twitter, establishing a connection may be “following” the user. In other environments, establishing a connection with an entity may mean subscribing to the information generated by that entity, or joining in a coalition.

In FIG. 7, block 720 determines whether there are more state elements 107 in the search feed 210. The search feed 210 is determined by the search pattern set as part of the other domain-specific desires 265 in the owner representation 130. The search pattern set is a set of context tokens (or regular expressions over context tokens) representing what the owner 104 is interested in.

While there are more state elements 107 in the search feed 210, the state tokenizer 105 continually extracts the next state element 107 and passes the associated context sequence 109 to block 750 (which is an embodiment of block 160). Block 750 relies on the token-value dictionary 760, which is part of the other domain-specific desires 265. For the incoming context sequence 109, block 750 uses the dictionary to sum up the values of each token in that sequence. Any context token that is not in the dictionary is assumed to have value 0. As described previously, tokens that the owner 104 is interested in have positive values, and tokens that the owner 104 is not interested in have negative values. If the sum of the values of the tokens in the context sequence 109 is determined to be above a predetermined threshold, the cyborg 103 connects with the entity 780. Connecting with users based on tokens in the token-value dictionary 760 provides the added benefit of building a community around the ideas embodied in those tokens.

If there is metadata associated with the state element 107, the cyborg 103 can optionally also use the token-value dictionary 760 to compute the sum of the tokens in the metadata, and it can require that the sum exceed a predetermined threshold before connecting. In a social media environment, the metadata may be the description the user has written for himself or herself on the profile. This metadata requirement can be in place of block 750. Or the invention can require that both block 750 and this requirement are satisfied before connecting, or it can require that only one of those is satisfied before connecting.

To avoid annoying other users, the cyborg 103 can optionally not connect with any user that it has already reached out to before. The cyborg 103 can know if it has ever connected with a user by keeping track of every user it has ever reached out to in the memory 117. In a social media environment such as Twitter, this would mean not following any user the cyborg 103 has previously followed in the past.

Optionally, the cyborg 103 can also establish a connection with any user that mentions it in a state element 107. In the Twitter example, this would mean the cyborg 103 can follow any Twitter user who mentions the cyborg 103 in a tweet or retweets a tweet posted by the cyborg 103.

### FIG. 8, Filtering Behavior Using the Tokenized Embodiment

FIG. 8 depicts the filtering of state elements 107 using the tokenized embodiment. In this embodiment, the cyborg 103 identifies a state element 107 as being of interest to the owner 104 by computing the probability that the owner 104 would generate the context tokens making up the state element 107. If that probability is above a predetermined threshold, the state element 107 is shown to the owner 104 and possibly broadcast to other users.

Consider the example of a natural language environment such as social media. In this case, the state elements 107 could be communications, such as tweets, and the context tokens would be the words making up the communication. By showing the owner 104 state elements 107 that are likely to have been generated by the owner 104, this approach automatically favors topics that the owner 104 is interested in and that are expressed in the manner of speaking used by the owner 104.

In FIG. 8, a behavior history 260 is tokenized using the state tokenizer. This behavior history can consist of actions in this domain or any other domain. For example, in a natural language domain such as social media, the behavior history could be an owner's 104 previous writing, such as a journal. The behavior history is then passed through the state tokenizer 105 and summarized into an N-gram model 815. The N-gram model 815 can be created by anyone of ordinary skill in the art, and many implementations exist, such as NgramModel from the Natural Language Toolkit (NLTK) software library. N-gram models use the previous context tokens to predict the probability of the next context token. For example, if the owner 104 often writes about going to the zoo, and in the text there is written the phrase “I went to the,” the word “zoo” would have a relatively high probability of being the next word.

When a state element 107 is extracted from the environment for consideration, it is tokenized by the state tokenizer 105. Block 850 then computes the likelihood that the owner 104 would have performed an action resulting in the considered context tokens using the N-gram model 815. It uses the N-gram model 815 to compute the estimated probability of each next context token in the context sequence 109 given a predetermined number of the previous context tokens. For example, if we are using two previous tokens to compute the probability (a tri-gram model) then, in one embodiment, the probability of the context token c₃ coming next in the context sequence 109 (c₁, c₂, c₃) could be given as

$$\frac{\# ( {c}_{1} , {c}_{2} , {c}_{3} )}{\# ( {c}_{1} , {c}_{2} , *)}$$

where #(c₁, c₂, c₃) is the number of times the sequence #(c₁, c₂, c₃) was seen in the tokenized behavior history, and #(c₁, c₂,*) is the number of times the sequence (c₁, c₂) was seen in the tokenized behavior history followed by any other token. Various methods can be used, such as falling back to a bi-gram or unigram model, when there are insufficient counts or when block 850 is computing the probability of the first two tokens.

The likelihood for the considered context sequence can then be an average of the individual probabilities, or some other aggregate of those individual probabilities. If at block 870 (which is an embodiment of block 170) the embodiment determines that the presented state element 107 is sufficiently likely, block 150 shows the state element 107 to the owner 104 or possibly rebroadcasts it if so configured.

In an alternative embodiment, block 850 can compute the negative log of the probability of each token and average those values together to give an entropy score. This computation can be done using the method named “entropy” of the NgramModel from NLTK. Using the entropy score embodiment, if block 870 determines that the entropy is below a predetermined threshold (low is good in this case, since we are averaging the negative log of the probability), the state element 107 is shown to the user 880.

The embodiment can optionally also additionally penalize short context sequences 109 by requiring a more stringent predetermined threshold for the considered context element to be shown to the owner 104.

In block 150, for an embodiment in a social media environment such as Twitter, the cyborg 103 can publically mark state elements 107 that the owner 104 would like to see. For example, on Twitter one can favorite a tweet, and on Facebook one can like a post. Publically marked state elements often act as an acknowledgment that the content was read and appreciated by the owner 104, thus helping build the relationship. Publically marking also allows the owner 104 just to look at those state elements that have been marked.

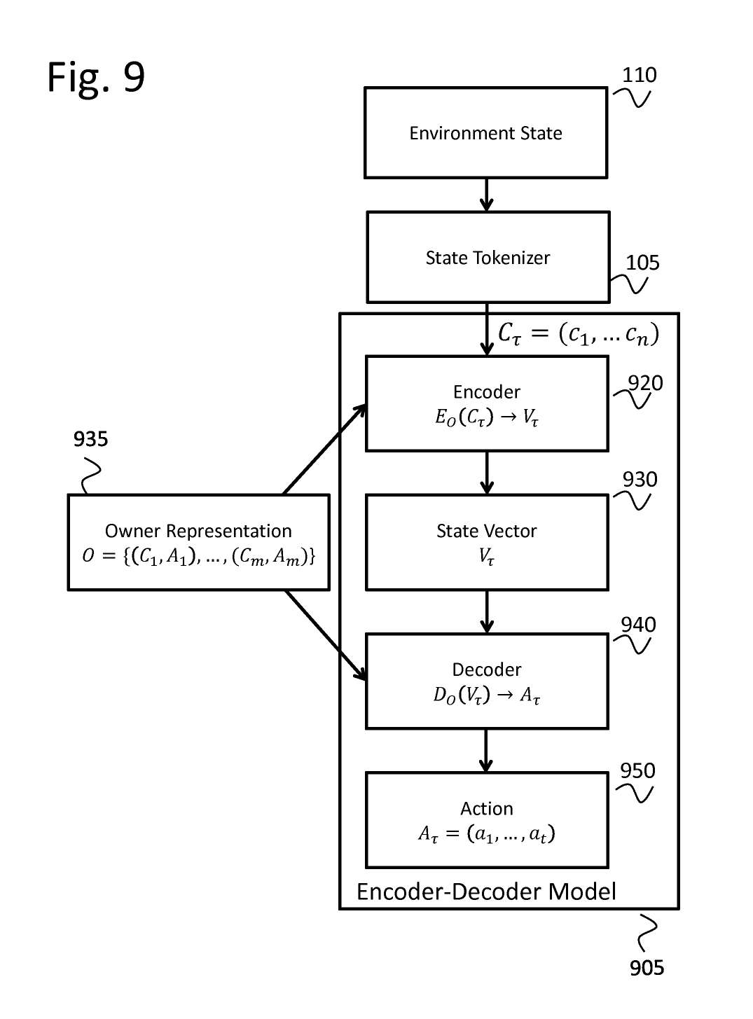

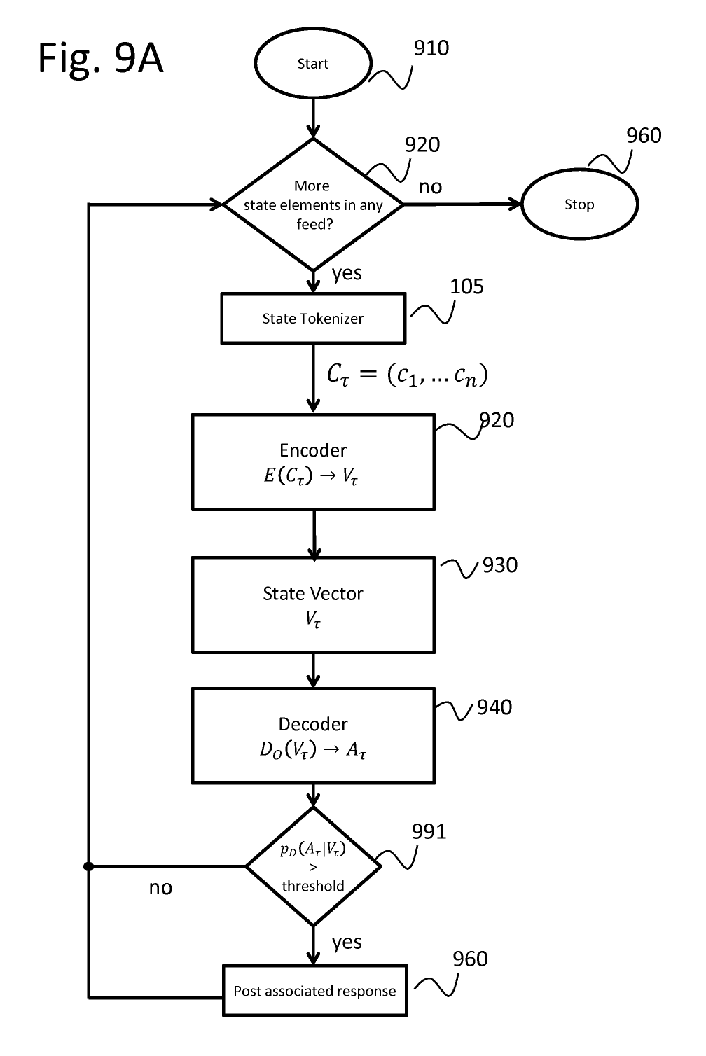

### FIG. 9: The Vectorized Embodiment

The vectorized embodiment enables the cyborg 103 to learn how to translate state elements 107 into actions 950 in a way that allows it to approximately mimic the actions of the owner 104. The embodiment uses an owner representation 935 O={(C₁,A₁), . . . , (Cₘ,Aₘ)} as training data where each member of the set is a pair (C_{τ},A_{τ}) consisting of the context sequence 109 from some environment state element 107 S_{τ} and the action 950 A_{τ} taken by the owner 104 in response to that environment state 110. Each action 950 A_{τ}=(a₁, . . . , aₜ) is composed of a sequence of action tokens. In a social media environment, an action 950 could be a communication, and the action tokens would be the words making up the communication, such as a tweet. In an MMOG environment, an action 950 could be something like attacking a monster, and the sequence of action tokens could be the sequence of individual moves used in the attack.

A naïve approach to mimicking the owner 104 with the cyborg 103 would be to use the state tokenizer 105 to tokenize the current state element 107 S_{τ} into the context sequence 109 C_{τ}, and if C_{τ}=Cᵢ for any pair (Cᵢ,Aᵢ)∈ O, then it could perform action 950 Aᵢ. This approach is limited because we want the cyborg 103 to be able to act as the owner 104 would even for situations that are not exactly represented in the owner representation 935. We want the cyborg 103 to be able to generalize from the experience of the owner 104.

The approach of this embodiment is to treat the problem as machine translation of natural language. Since each action 950 A_{τ}=(a₁, . . . , aₜ) is of a sequence of action tokens, this means that for a pair (C_{τ},A_{τ})∈ O we can think of it as a translation problem of context tokens C_{τ}=(c₁, . . . cₙ) to the action tokens of an action 950 A_{τ}=(a₁, . . . , aₜ), much as one considers a translation between a sentence of English words to a sentence of French words.

One recent approach used in machine translation, and the approach adopted in this embodiment, is to learn a parameterized encoder-decoder model 905 ED. The model 905 ED, for a given context sequence 109 C_{τ}, computes a conditional probability distribution that is defined over actions 950 A_{τ}. The model is parameterized by the parameters θ, and we denote the probability given to action 950 A_{τ} given context sequence 109 C_{τ} with parameter values θ as p_{ED}_{_{θ}}(A_{τ}|C_{τ}).

Our goal is to learn a set of parameter values θ that maximizes the following equation over the training examples in our owner representation 935 O={(C₁,A₁), . . . , (Cₘ,Aₘ)}.

$${max}_{θ} \frac{1}{m} {\sum }_{τ = 1}^{m} log {p}_{{ED}_{θ}} ( {A}_{τ} \vert {C}_{τ} )$$

In one embodiment, the encoder 920 and decoder 940 can each be a recurrent neural network (RNN), and the parameter values θ can be maximized using gradient descent or another optimization method. Building and training the RNN encoder-decoder 905 can be accomplished by anyone of ordinary skill in the art. The particular format of the encoder 920 and decoder 940 is not crucial for the working of the invention, but so the reader can see how it is used in the invention, we describe how an encoder 920 and decoder 940 could be built using RNNs.

In an embodiment, the encoder 920 E_{O} is an RNN that encodes a context sequence 109 C_{τ}=(c₁, . . . cₙ) using the equation

hₜ=f_{E}(hₜ₋₁, cₜ).

Where f_{E} is a parameterized, recurrent nonlinear function. It is referred to as “recurrent” because it generates a sequence of values where the next value is a function of a previous value, in this case, the vector hᵢ. It is nonlinear because it may include a nonlinear component, such as a sigmoid. The vector hᵢ encodes the sequence up to position i, and h₀ is a vector of zeros or random small values. For a context sequence 109 of length n, such as in C_{τ}=(c₁, . . . cₙ), we let V_{τ}=hₙ be the encoded state vector 930 of the context sequence 109.

The decoder 940 D_{O} generates the sequence of action tokens making an action 950 A_{τ}=(a₁, . . . , aₜ) given a state vector 930. If we let aₜ be the action token at position t, then the decoder 940 can be represented as the two equations

aₜ=g(hₜ)

hₜ=f_{D}(hₜ₋₁, aₜ₋₁, V_{τ}).

The function f_{D} is a parameterized, recurrent nonlinear function. The vector hᵢ represents the state of the decoder 940 at position i, and we can let h₀=V_{τ} and let a₀ be a special beginning action token.

We can then define g as giving the probability for the jth action token to be taken at sequence position t

$${p}_{D} ( {a}_{t , j} \vert {a}_{t - 1} , … , {a}_{0} , {V}_{τ} ) = \frac{{e}^{{w}_{j} {h}_{t}}}{{\sum }_{{j}^{′} = 1}^{J} {e}^{{w}_{{j}^{′}} {h}_{t}}}$$

The function g can be paraemterized by a matrix W so that W is part of the parameters that make up θ, and wⱼ is the row of W corresponding to action token j. To generate (decode) the action 950 A_{τ}=(a₁, . . . , aₜ) from the state vector 930 V_{τ}, the decoder 940 can start with the special start token a₀, then given a₀, it can find the next most likely token a₁, then given (a₀, a₁), it can find the next most likely token, and so on, until a special end-of-sequence token a_{end} becomes the most likely. In other embodiments, it can try generating multiple sequences, searching for an entire sequence that is likely, such as in Beam search.

So that the decoder 940 defines a conditional probability distribution that is defined over actions 950, we define

$${p}_{D} ( {A}_{τ} \vert {V}_{t} ) = {\prod }_{i = 1}^{t} {p}_{D} ( {a}_{t} \vert {a}_{t - 1} , … , {a}_{0} , {V}_{τ} )$$

In an alternative embodiment, the owner representation 935 O={(C₁,A₁), . . . , (Cₘ,Aₘ)} can be supplemented with the data from other users. In one embodiment, the encoder-decoder model 905 is pre-trained with data from other users, and then the data from the owner is used to finish training. This can be useful in situations when the owner does not have a large amount of history as represented by the owner representation 935 O={(C₁,A₁), . . . , (CₘAₘ)}.

In other embodiments of the encoder 920 and decoder 940, the functions f_{E}, g, and f_{D} can have multiple layers and can have complicated gates, such as by being a long short-term memory unit. They can also have different forms of regularization to help prevent overfitting. As an example, for the decoder 940, instead of having aₜ=g(hₜ), we could have aₜ=g(hₜ, aₜ₋₁, V_{τ}) and we could modify p_{D} accordingly. The invention does not depend of the specific embodiment of the encoder 920 and decoder 940.

We can now describe FIG. 9. In this embodiment, we replace the Action Engine 180 with the union of the Encoder-decoder model 905 and the owner representation 935 depicted in FIG. 9. The encoder-decoder model 905 converts the context sequences 109 coming from the state elements 107 of the environment state 110 into vectors; it also converts the context sequences 109 that form part of the owner representation 935 into vectors, and it makes decisions based on both of those vectors. The embodiment converts context sequences 109 into vectors in such a way that context sequences 109 representing similar state elements 107 are mapped to vectors that are close to each other in vector space. This idea of having vectors and the distances between them represent the environment state 110 and behavior history 935 of the owner 104 provides the advantage of increased generalization over the tokenized embodiment. Practically, this can mean that the cyborg 103 will have a better idea of what to do when it encounters previously unseen context tokens.

The owner representation 935 O={(C₁,A₁), . . . , (Cₘ,Aₘ)} in this embodiment is represented as a set where each member of the set is a pair (C_{τ},A_{τ}) consisting of the context sequence 109 from some environment state element 107 S_{τ} and the action 950 A_{τ} taken by the owner 104 in response to that environment state 110.

The encoder 920 E_{O}(C_{τ})→V_{τ} takes a context sequence 109 and converts it into a state vector 930 V_{τ}, which is a vector of real numbers.

Each state vector 930 V_{τ} is a vector that is created by the encoder 920 so that similar sequences of context tokens have similar vectors. For example, the state vector 930 for the natural language communication “I want a taco” should be more similar to the natural language communication “I desire a sandwich” than to the communication “I walked in the woods.”

The decoder 940 D_{O}(V_{τ})→A_{τ} mimics the behavior of the owner 104 as provided in the owner representation 935 O by generating an action 950 A_{τ} given state vector 930 V_{τ} that is similar to what the owner 104 would do in the presence of state vector 930 A_{τ}.

Each action 950 A_{τ}=(a₁, . . . , aₜ) consists of a sequence of action tokens. An action 950 can be a communication, where in this case the action tokens would be the individual words. In another environment, such as an MMOG, the action tokens would correspond to a sequence of moves. In some environments, a simple action 950 may consist of a single action token.

### FIG. 9A: The Vectorized Embodiment for Response Behavior

Once trained, the vectorized embodiment may be used for response behavior. In this embodiment, the algorithm would be trained using the owner representation 935 O={(C₁,A₁), . . . , (Cₘ,Aₘ)} such that each pair is of the form (Cᵢ,Aᵢ), where Cᵢ is a context sequence 109 derived from a state element 107 Sᵢ the owner 104 responded to in the past, and Aᵢ is the response to that state element 107. Using this owner representation 935 for training, the cyborg 103 would learn to respond as the owner 104 would to new state elements 107 converted to context sequences 109.

FIG. 9A shows the process after training. When a new context sequence 109 is fed to the encoder 920, it is converted into a state vector 930 V_{τ}, and then converted by the decoder 940 D_{O} into an action 950 V_{τ}. Then, block 991 (which is an embodiment of block 160) determines whether the probability p_{D}(A_{τ}|V_{τ}) was above a predetermined threshold, and if so, the cyborg 103 takes the action 950 to issue the response.

In an alternative embodiment, the cyborg 103 could respond to general states of the environment. In such an embodiment, the algorithm can be trained using an owner representation 935 O={(C₁,A₁), . . . , (Cₘ,Aₘ)} that consists of pairs such that each pair is of the form (Cᵢ,Aᵢ), where Cᵢ is a context sequence 109 representing a general state of the world, for example the front page of an online news source or the tweets from the owner's 104 connections within a time period, and Aᵢ is the owner's 104 response.

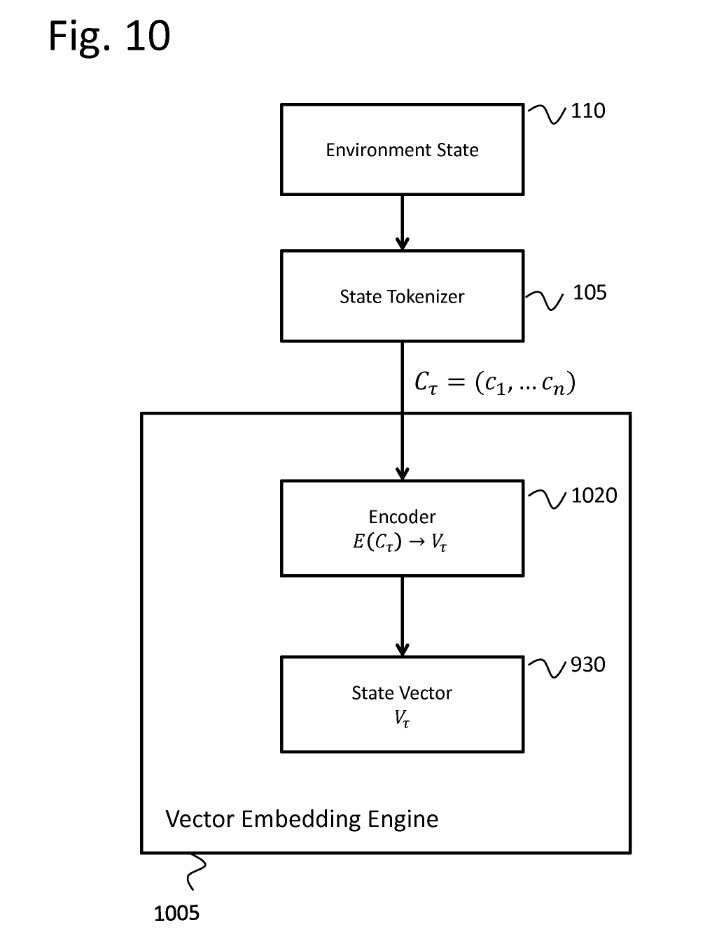

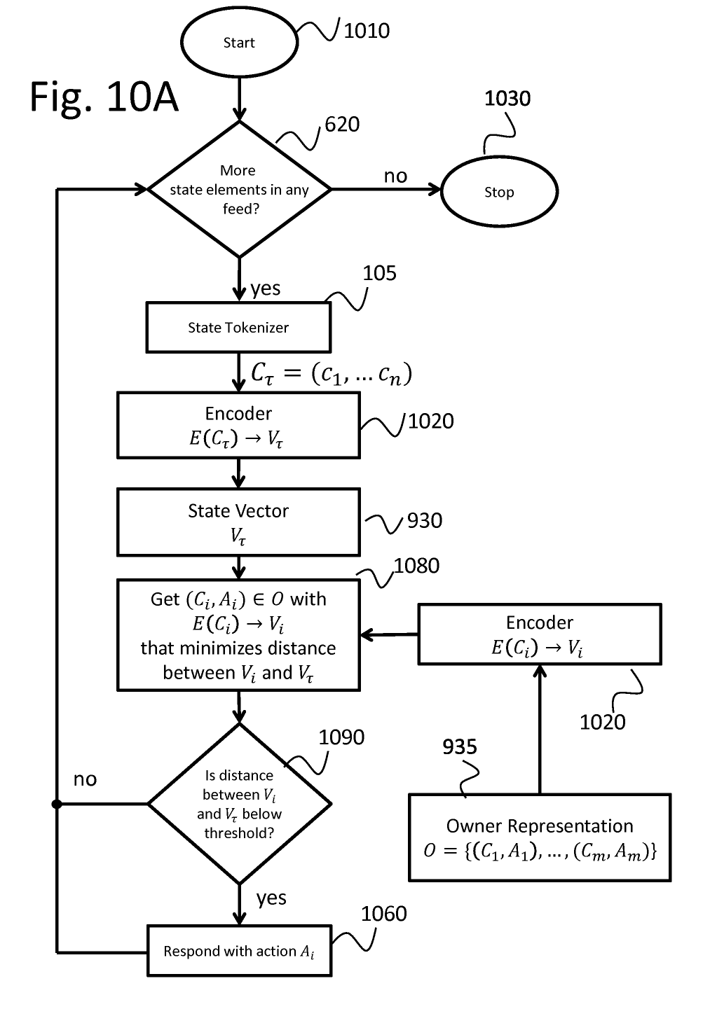

### FIG. 10: Alternative Vectorized Embodiment: Vector Embedding Engine

The encoder-decoder model 905 uses the encoder 920 to convert a context sequence 109 into a state vector 930 that is then used as part of the decoder 940 to generate the action 950. In an alternative embodiment, the state vector 930 can be generated directly by an independent encoder 1020, as depicted in FIG. 10, and it can be used in behaviors as depicted in FIG. 10A.

FIG. 10 Shows that the Vector Embedding Engine 1005 Receives a Context Sequence 109 from the environment state 110 and converts it into a state vector 930. We first describe how a continuous bag of words (CBOW) model can be used to generate a state vector 930 for each context token, and we then describe how the independent encoder 1020 can be embodied as an extension to CBOW (called a distributed memory model). This encoder 1020 can then be used to generate a state vector 930 for each context sequence 109. Both CBOW and its extension, the distributed memory model, can be implemented by anyone of ordinary skill in the art, but we explain them here for completeness.

To convert individual context tokens to vectors using CBOW, we use windows over the context sequence 109. For natural language, these windows are one dimensional, and for images these windows can be parts of the image. The general idea is that tokens that occur together in windows should have similar state vectors 930.

If in our training data, context token cₜ often shows up in a window with the context tokens cₜ₋₂, cₜ₋₁, cₜ₊₁ and cₜ₊₂, then we want our CBOW model M to maximize the probability

p_{M}(cₜ|cₜ₋₂, cₜ₋₁, cₜ₊₁, cₜ₊₂)

Equivalently, we want to minimize the error J

J=−log(p_{M}(cₜ|cₜ₋₂, cₜ₋₁, cₜ₊₁, cₜ₊₂))

CBOW model M consists of two matrices of parameters to be learned, W ∈ [symbol] ^{v×|C|} and W′ ∈ [symbol] ^{|C|×v}, where C is the set of all possible context tokens, and v is the length of the state vector 930 V_{τ} that we wish to learn.

The matrices of parameters W and W′ can be randomly initialized, and for a particular window, we can let h be the sum of the column vectors of W associated with cₜ₋₂, cₜ₋₁, cₜ₊₁ and cₜ₊₂. If we let W′_{t:} be the row of W′ corresponding to context token cₜ, then we can let

$${p}_{M} ( {c}_{t} \vert {c}_{t - 2} , {c}_{t - 1} , {c}_{t + 1} , {c}_{t + 2} ) = {p}_{M} ( {c}_{t} \vert h ) = \frac{{e}^{{W}_{t :}^{′} h}}{{\sum }_{i ∈ C} {e}^{{W}_{i :}^{′} h}}$$

Our error J that we wish to minimize becomes

$$J = - log ( \frac{{e}^{{W}_{t :}^{′} h}}{{\sum }_{i ∈ C} {e}^{{W}_{i :}^{′} h}} )$$

This error can be minimized by gradient descent over W and W′. The vector Vₜ for any context token cₜ can then be column t of matrix W or row t of matrix W′, or some combination of the two.

We just described how to convert individual context tokens into state vectors 930. However, embodiments of this invention generally compute a state vector 930 V_{τ} for a context sequence 109 C_{τ} instead of for the individual tokens cₜ. In one embodiment, this invention computes a state vector 930 V_{τ} for context sequence 109 C_{τ} using the extension of CBOW called a distributed memory model. The distributed memory model can also be implemented by anyone of ordinary skill in the art, but we explain it here for completeness.

In one embodiment, entire context sequences 109 are converted to state vectors 930 in a similar manner to how individual context tokens are converted to state vectors 930. The matrices W and W′ are extended to be W ∈ [symbol] ^{v×(|C|+|Q|)} and W′ ∈ [symbol] ^{(|C|+|Q|)×v} where Q is the set of all context sequences 109 C_{τ} seen in the training data. For a given window of context tokens in a context sequence 109 C_{τ}, in addition to letting h be the sum of the column vectors of W associated with the context tokens in the context window, we add the column vector of W associated with to the vector h. The intuition is that we should learn a state vector 930 V_{τ} for C_{τ} that allows the model M to do a good job of predicting the tokens in C_{τ}.

With the column vector for C_{τ} from W added to h, we can modify our previous equation for computing the probability to be

$${p}_{M} ( {c}_{t} \vert {c}_{t - 2} , {c}_{t - 1} , {c}_{t + 1} , {c}_{t + 2} , {C}_{τ} ) = {p}_{M} ( {c}_{t} \vert h ) = \frac{{e}^{{W}_{t :}^{′} h}}{{\sum }_{i ∈ C} {e}^{{W}_{i :}^{′} h}}$$

We can then learn the parameters of W and W′ by gradient descent just as in the CBOW model, and we can extract the state vector 930 V_{τ} for context sequence 109 C_{τ} just as before. After training, when a previously unseen context sequence 109 C_{τ} is presented to the encoder 1020, the matrices W and W′ can be expanded and the model can be retrained or trained beginning from the existing values in matrices W and W′ for faster results.

Alternative embodiments for defining the state vector 930 are possible. For example, one can generate state vectors 930 for individual context elements and aggregate them, possibly using a weighted averaging, into a state vector 930 for the context sequence 109. The invention does not depend on the specific embodiment for using parameterized, recurrent nonlinear functions to learn the state vector 930.

FIG. 10A: Multiple Behaviors with the Vector Embedding Engine

FIG. 10A shows how the invention can use the vector embedding engine 1005 in multiple embodiments. In one embodiment, the invention can use the vector embedding engine 1005 for response behavior. In this embodiment, the owner representation 935 O={(C₁,A₁), . . . , (Cₘ,Aₘ)} consists of pairs where each pair is of the form (Cᵢ,Aᵢ), where Cᵢ is a context sequence 109 representing a communication the owner 104 responded to in the past and action 950 Aᵢ is the response to that communication. To determine the possible response to a new state element 107 S_{τ}, the state element 107 S_{τ} is tokenized into 109 C_{τ}=(c₁, . . . , cₙ) by the state tokenizer 105, the encoder 1020 converts it into a state vector 930 V_{τ}. Then, block 1080 extracts the pair (Cᵢ,Aᵢ)∈ O with E(Cᵢ)→Vᵢ where Vᵢ is closest to V_{τ}. Another way to describe block 1080 is to say that it extracts the pair (Cᵢ,Aᵢ)∈ O where E(Cᵢ) is closest to V_{τ}, and it labels E(Cᵢ) as Vᵢ. This closeness can be measured using any standard distance metric for vectors, such as Euclidean distance.

Block 1090 (which is an embodiment of block 160) determines whether the distance between Vᵢ and V_{τ} is below a predetermined threshold. If it is , the cyborg 103 responds with action 950 Aⱼ. In a social media environment, the response could be a communication, or in a MMOG environment, the response could be a sequence of movements. Note that in contrast to FIG. 9A, reach response action 950 Aᵢ must exist as part (Cᵢ,Aᵢ)∈ O in the owner representation 935 O={(C₁,A₁), . . . , (CₘAₘ)}. The embodiment of FIG. 9A allows the responses response action 950 Aᵢ to be novel while still being in line with the wishes of the owner 104 per to the owner representation 935 O={(C₁,A₁), . . . , (Cₘ,Aₘ)}.

In another embodiment, the invention can use the vector embedding engine 1005 for connecting behavior. In this embodiment, the owner representation 935 O={(C₁,A₁), . . . , (Cₘ,Aₘ)} consists of pairs where each pair is of the form (Cᵢ,Aᵢ), where Cᵢ is a context sequence 109 representing the metadata of an entity, and action 950 Aᵢ is a single Boolean value indicating whether the owner 104 connected with that entity or not.

In another embodiment, the invention can use the vector embedding engine 1005 for filtering. In this embodiment, the owner representation 935 O={(C₁,A₁), . . . , (Cₘ,Aₘ)} consists of pairs where each pair is of the form (Cᵢ,Aᵢ), where Cᵢ is a context sequence 109 representing the item to possibly be filtered, and action 950 Aᵢ is a Boolean indicating whether the owner 104 decided he or she wanted to see it (or have it rebroadcasted). For example in a social media site such as Twitter, the action 950 Aᵢ could be if the owner 104 favorited the tweet or retweeted it.

In another embodiment, the invention can use the encoder 1020 to generate a state vector 930 which is then decoded by the decoder 940 of FIG. 9 and FIG. 9A. It is an alternative way to implement the encoder-decoder model. Since the encoder 1020 is learned separately, (note that encoder 920 is denoted by E_{O} because it is learned using the owner representation 935 O, and encoder 1020 it is denoted by E as it is learned in an unsupervised manner), our goal is to learn a set of parameter values D_{θ} for the decoder 940 that maximizes p_{D}_{_{θ}} (A_{τ}|V_{τ}) in the following equation over the training examples in our owner representation 935 O={(C₁,A₁), . . . , (Cₘ,Aₘ)}

$${max}_{θ} \frac{1}{M} {\sum }_{τ = 1}^{M} log {p}_{{D}_{θ}} ( {A}_{τ} \vert {C}_{τ} )$$

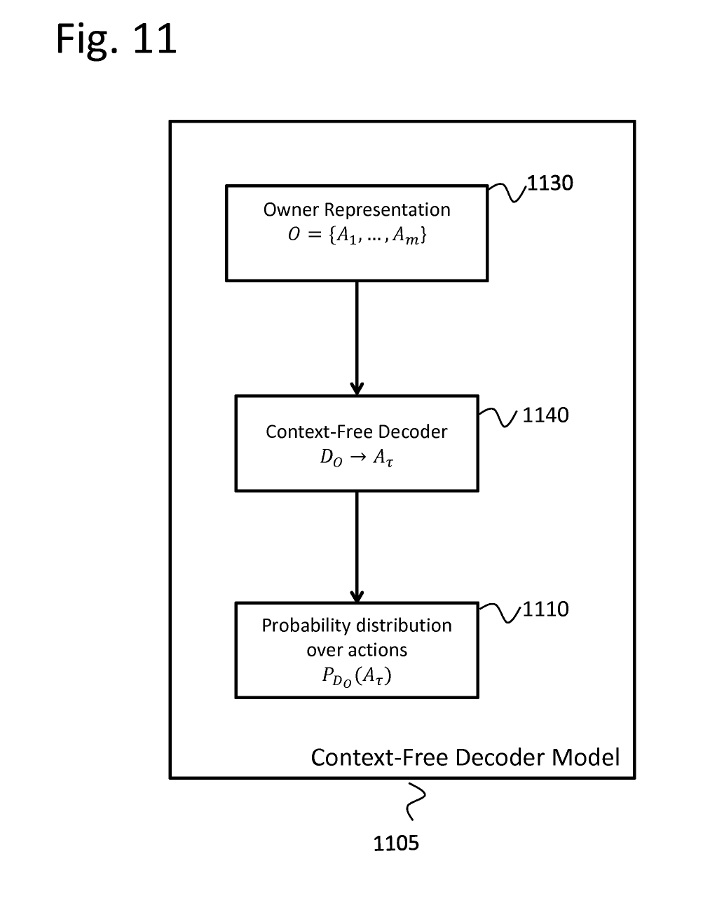

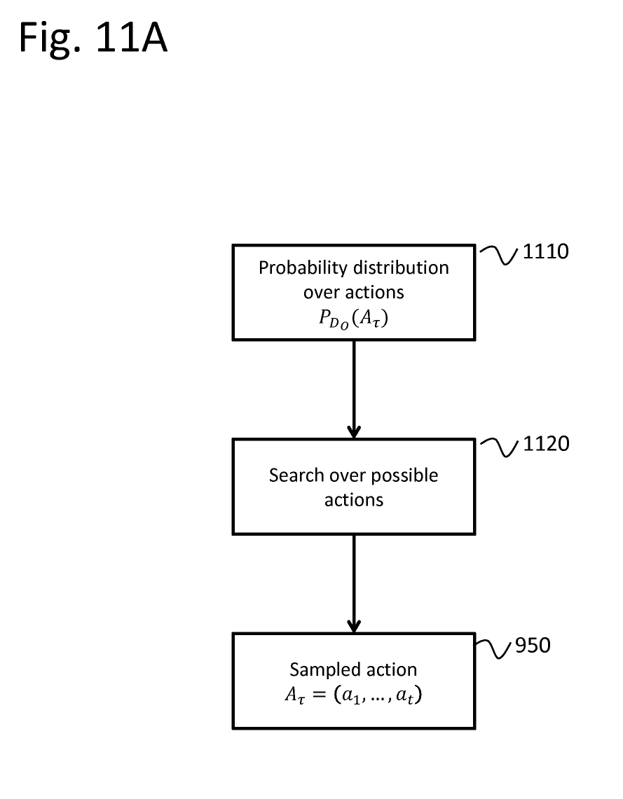

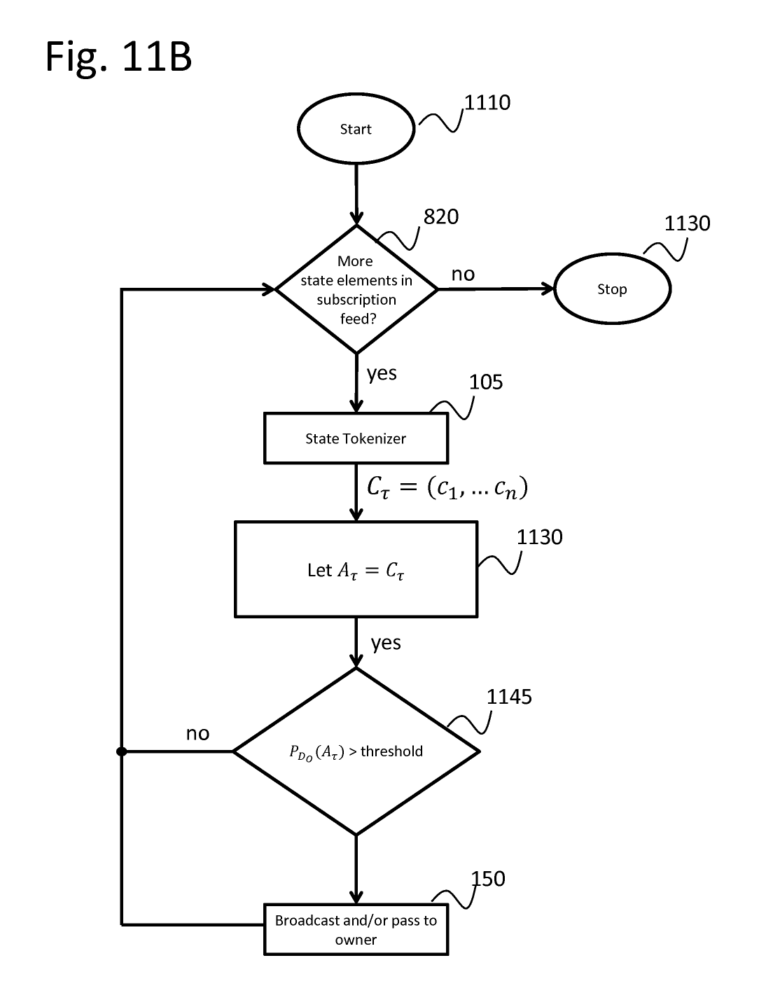

### FIG. 11: Context-Free Decoder Model

FIG. 11 depicts an embodiment that uses a decoder 1140 to create a probability distribution 1110 P_{D}_{_{O}} (A_{τ}) defined over actions 950 the owner 104 would take without regard to context. Because this embodiment is not concerned with context, the owner representation 1130 O={A₁, . . . , Aₘ} takes the form of a set of actions 950, where, as before, each action 950 A_{τ}=(a₁, . . . , aₜ) consists of a sequence of action tokens.

The context-free decoder model 1105 is parameterized by the parameters θ, and we denote the probability given to action 950 A_{τ} with parameter values θ as p_{CFD}_{_{θ}}(A_{τ}). Our goal is to learn a set of parameter values θ that maximizes the following equation over the training examples in our owner representation 1130 O={A₁, . . . , Aₘ}.

$${max}_{θ} \frac{1}{m} {\sum }_{τ = 1}^{m} log {p}_{{CFD}_{θ}} ( {A}_{τ} \vert {C}_{τ} )$$

The context-free decoder 1140 generates a sequence of action tokens making an action 950 A_{τ}=(a₁, . . . , aₜ) given a state vector 930. If we let aₜ be the action token at position t, then the decoder can be represented as the two equations

aₜ=g_{CFD}(hₜ)

hₜ=f_{CFD}(hₜ₋₁, aₜ₋₁).

The function f_{CFD} is a parameterized, recurrent nonlinear function, hᵢ is a vector summarizing the state of the decoder at sequence position i, and h₀ is a vector of zeros or small values. We can let a₀ be a special beginning action token. The decoder continues to generate action tokens until a special end-of-action token a_{end} is generated.

We can then define g_{CFD} as a probability distribution p_{CFD}_{_{θ}}

$${p}_{{CFD}_{θ}} ( {a}_{t , j} \vert {a}_{t - 1} , … , {a}_{0} ) = \frac{{e}^{{w}_{j} {h}_{t}}}{{\sum }_{{j}^{′} = 1}^{J} {e}^{{w}_{{j}^{′}} {h}_{t}}}$$

Where a_{t,j} is the jth action token to be taken at sequence position t. The function g_{CFD} can be paraemterized by a matrix W so that W is part of the parameters that make up θ, and wⱼ is the row of W corresponding to action token j.

The context-free decoder 1140 defines a probability distribution over actions

$${p}_{{CFD}_{θ}} ( {A}_{τ} ) = {\prod }_{i = 1}^{t} {p}_{{CFD}_{θ}} ( {a}_{t} \vert {a}_{t - 1} , … , {a}_{0} )$$

As before, the values for the parameters θ that allow the context-free decoder to best match the owner representation 1130 O can be found using gradient descent, or some other optimization method. We label the probability distribution generated by the context-free decoder with the set of parameters that best fit the owner representation 1130 O as 1110 P_{D}_{_{O}}(A_{τ}).

In an alternative embodiment, the owner representation 1130 O={A₁, . . . , Aₘ} can be supplemented with the data from other users. In one embodiment, the context-free decoder model 1105 is pre-trained with data from other users, and then the data from the owner is used to finish training. This can be useful in situations when the owner does not have a large amount of history as represented by the owner representation 1130 O={A₁, . . . , Aₘ}.

In other embodiments of the context-free decoder model 1105, the functions f_{CFD} and g_{CFD} can have multiple layers and can have complicated gates, such as by being a long short-term memory unit. They can also have different forms of regularization to help prevent overfitting. The invention does not depend of the specific embodiment for defining the context-free decoder 1140 using parameterized, recurrent nonlinear functions.

### FIG. 11A: Using the Context-Free Decoder Model for Baseline Behavior

FIG. 11A shows how an embodiment of the context-free decoder model 1105 can be used to generate baseline behavior. The embodiment takes the probability distribution over actions P_{D}_{_{O}}(A_{τ}) and uses a search mechanism 1120 to extract a sample action 950 that can then be taken by the cyborg 103. The search mechanism 1120 is used because each action 950 A_{τ}=(a₁, . . . , aₜ) is a sequence of action tokens.

In one embodiment, the search mechanism 1120 starts with the special start token a₀, then given a₀, it finds the next most likely token a₁, then given (a₀, a₁), it finds the next most likely token, and so on, until the special end-of-sequence token a_{end} becomes the most likely. In other embodiments, it tries generating multiple sequences, searching for an entire sequence that is likely, such as in Beam search. The invention does not depend on the specific embodiment for searching for a likely action 950 V_{τ}.

In a natural language environment, such as a social network like Twitter, the cyborg 103 could generate tweets that would be the kind of tweets that the owner 104 would generate himself or herself. In an MMOG environment, the cyborg 103 could use this embodiment to mimic the standard behavior of the owner 104, such is mining for ore.

### FIG. 11B: Using the Context-Free Decoder Model for Filtering Behavior

FIG. 11B depicts an embodiment in which the context-free decoder model 1105 filters state elements 107. The idea, as in FIG. 8, is to filter state elements 107 based on the probability that they could have been generated by the owner 104.

A state element 107 S_{τ} is tokenized by the state tokenizer 105 and results in a context sequence 109 C_{τ}=(c₁, . . . cₙ). Block 1130 then converts that context sequence 109 C_{τ}=(c₁, . . . cₙ) into an action 950 A_{τ}=(c₁, . . . cₙ) by setting each action token to be the corresponding context token. Block 1145 takes the probability distribution over actions 1110 P_{D}_{_{O}} and looks at the probability P_{D}_{_{O}} (A_{τ})that the context sequence 109 A_{τ}=C_{τ} could have been generated by the owner 104. If P_{D}_{_{O}}(A_{τ}) is above a predetermined threshold, the state element is shown to the owner 104 or rebroadcast 150, depending on how the cyborg 103 is configured by the owner 104.

I claim:

1. An apparatus for enabling an owner's wishes to be carried out in a digital environment, comprising a processor or processors, a memory, and an application code, and further comprising:
an environment state comprising feeds of state elements from the digital environment;
an owner representation that encodes the wishes of the owner for acting in the digital environment;
a state tokenizer that converts the state elements into state context sequences representing said state elements; and
a behavior engine that uses said state context sequences and said owner representation to act in the digital environment in approximate accordance with the owner representation.

2. The apparatus of claim 1 wherein the behavior engine generally only takes actions when it can approximate the owner's wishes, whereby the apparatus is less likely to annoy other users in the digital environment.

3. The apparatus of claim 1 wherein the behavior engine uses a context-sensitive action mapping to perform response behavior.

4. The apparatus of claim 1 wherein the behavior engine:
uses a token-value dictionary to assign values to tokens in state context sequences, and establishes a connection with those entities associated with the state context sequences whose sum of token values is greater than a specified threshold; or
uses a state tokenizer that converts metadata for entities in the digital environment into entity context sequences and uses a token-value dictionary to assign values to tokens in entity context sequences, and establishes a connection with those entities whose sum of token values is greater than a specified threshold;

5. The apparatus of claim 1 wherein the owner representation consists of pairs, with each pair consisting of a context sequence and an action, wherein each action consists of a sequence of action tokens, and wherein the behavior engine comprises:
an encoder comprising a parameterized, recurrent nonlinear function that converts state context sequences into state vectors; and
a decoder comprising a parameterized, recurrent nonlinear function that converts said state vectors into actions;
and the parameters of the encoder and decoder are trained to match the owner representation whereby the behavior engine performs response behavior similar to how the owner would.

6. The apparatus of claim 1 wherein the owner representation consists of pairs, with each pair consisting of a context sequence and an action, wherein each action consists of a sequence of action tokens, and wherein the behavior engine comprises:
an encoder comprising a parameterized, recurrent nonlinear function that converts each state context sequence into a first state vector;
an extractor that gets the action from the owner representation whose context sequence, when mapped to a second state vector via said encoder, is closer than any other pair in the owner representation to the first state vector;
a comparator that determines whether the distance between the second state vector and the first state vector is below a threshold, and if it is, responds with said action.

7. The apparatus of claim 6 wherein the context sequences of the owner representation correspond to metadata associated with entities, and the corresponding action is a Boolean indicating whether the owner connected with that entity, whereby the apparatus makes connections with entities similar to how the owner would.

8. The apparatus of claim 1 wherein the owner representation consists of a set of actions, wherein each action consists of a sequence of action tokens, and wherein the behavior engine comprises:
a decoder comprised of a parameterized, recurrent nonlinear function that generates a probability distribution over actions consistent with the owner representation; and
a search mechanism that finds a likely sequence of action tokens making up an action;
whereby the behavior engine is able to perform baseline behaviors similar to how the owner would.

9. The apparatus of claim 5 wherein the owner representation consists of pairs from one or more users, further comprising means for enabling the behavior engine to simulate a human in an exchange lasting multiple iterations with another user in the digital environment.

10. The apparatus of claim 1 further comprising means for transferring skills in the digital environment from the owner to another user or from another user to the owner.

11. The apparatus of claim 5 further comprising means for transferring skills in the digital domain from the owner to another user or from another user to the owner.

12. The apparatus of claim 1 wherein the behavior engine disconnects with an entity after connecting with the entity if said entity does not reciprocate the connection within a predetermined number of days specified by the owner.

13. The apparatus of claim 1 wherein the behavior engine adds an entity who directs a communication to the owner or mentions the owner in a state element to a public list.

14. The apparatus of claim 4 further comprising means for building a community around ideas corresponding to tokens in the token-value dictionary.

15. The apparatus of claim 7 further comprising means for building a community around ideas corresponding to tokens in the token-value dictionary.

16. An apparatus for showing an owner parts of a digital environment that will interest him or her, comprising a processor or processors, a memory, and an application code, and further comprising:
an environment state comprising feeds of state elements from the digital environment;
an owner representation that encodes the behavior history of the owner;
a state tokenizer that converts the state elements into state context sequences representing said state elements; and
a filter engine that uses an owner behavior history and computes the likelihood that the owner could have generated each state context sequence, and if the computed likelihood of some context sequence associated with a state element having been generated by the owner is estimated to be above a predetermined threshold performs one or more of:
showing said state element to the owner;
broadcasting said state element to the connections of the owner; or
publically marking said state element.

17. The apparatus of claim 16 wherein the filter engine further comprises:
an encoder comprising a parameterized, recurrent nonlinear function that converts the state context sequence for said state element into a first state vector;
an extractor that gets the context sequence from the owner representation that, when mapped to a second state vector via said encoder, is closer than any other context sequence in the owner representation to the first state vector;
a function that sets the likelihood of the owner having generated said state element to be the distance between the second state vector and the first state vector.

18. The apparatus of claim 16 wherein the owner representation consists of a set of actions, and the filter engine further comprises:
a context-free decoder comprising a parameterized, recurrent nonlinear function that defines a probability distribution over actions that approximates that of the owner representation; and
a function that treats the state context sequence as an action and sets the likelihood that the owner could have generated said state context sequence to be the probability for said action given by said probability distribution.
